(19) United States
(12) Patent Application Publication
(10) Pub. No.: US 2013/0151367 A1
(43) Pub. Date: Jun. 13, 2013

(54) SYSTEMS AND METHODS OF PROVIDING A VOLUME AND REVENUE MAXIMIZING RETAIL SALES PLATFORM

(71) Applicant: INTEGRATED HOLDINGS LLP, New York, NY (US)

(72) Inventor: Ronen Lazar, Toronto (CA)

(73) Assignee: INTEGRATED HOLDINGS LLP, New York, NY (US)

(21) Appl. No.: 13/684,270

(22) Filed: Nov. 23, 2012

Related U.S. Application Data
(60) Provisional application No. 61/562,786, filed on Nov. 22, 2011.

(51) Int. Cl. G06Q 30/06

(52) U.S. Cl. CPC G06Q 30/0611
USPC 705/26.4

(57) ABSTRACT

Computer-implemented methods and systems of providing a volume and revenue maximizing retail sales platform is provided. In some embodiments, a sales offering of one or more comparable items associated with a vendor(s) is transmitted, by a network server, to a plurality of potential buyers. Purchase offers are received from each of a plurality of interested buyers during a sales offer period. A first average purchase offer is determined by an application computer processor, comprising an average of at least a portion of the purchase offers received. The first average purchase offer is compared with a sales trigger price associated with the vendor(s). A sale is executed to each interested buyer whose purchase offer was included in the first average purchase offer, when the first average purchase offer is within a predefined range associated with the sales trigger price, and when a first predefined volume of purchase offers have been received.

### RELATED APPLICATIONS

This Application claims priority to U.S. Provisional Application No. 61/562,786, filed on Nov. 22, 2011, which is hereby incorporated by reference herein in its entirety.

### FIELD OF THE INVENTION

This invention relates generally to the sale of products and services and more specifically to systems and methods for increasing the volume of sales transactions between a single vendor and one or more perspective buyers in a sales offering including one or more identical or substantially identical and/or comparable products or sets of products and/or services that are limited in quantity within a specified time period, for example through a website on the Internet. In some embodiments, the sale of products and services is contingent on perspective buyers each submitting their highest offer price for quantity of one or more of a product or service. The offers are mathematically averaged or otherwise calculated compared to the available quantity, in order to reach an average or otherwise calculated price, which is then compared to a hidden sales trigger price selected by the vendor or a third party to determine who the buyers are and maximize the volume of sales transactions.

### BACKGROUND OF THE INVENTION

Retailing is the exchange of products and services between a vendor and a buyer. Retailing typically employs a vendor controlled format whereby the vendor determines the non-negotiable fixed price at which the products and/or services are sold.

As part of competitive retail strategies, two vendors may offer an identical or substantially identical product or service at two different prices, whereby one vendor may offer the product or service for less than a second vendor and look to achieve a higher volume of sales than their competing vendor. In order to avoid losing out on sales to perspective buyers who indicate interest in purchasing products or services from one specific retailer despite, the fact that pricing is higher than what is being made available by a competitor, some retailers employ a price match policy whereby they will match the price a competitor publishes for an identical product or service in order to generate a high volume of sales.

A recently developed sales format, known as the daily deal format, advertises discounted pricing, for example 50-90% off suggested retail pricing, based on a minimum volume of products or services being purchased within a specified timeframe. This sales format is conducive to selling volume of products and services but does not maximize revenue. Additionally, heavily discounted pricing is viewed as unsustainable by many vendors and is deemed to harm established product and services brands.

Auctions are an additional way to negotiate a price related to the sale of products and services based on the consumer demand.

In proxy bid style auctions, individual bidders compete with one another and offer increasing bids for products and services above a specific minimum bid, resulting in there being one winner, with the remaining bidders left empty handed. As a result, vendors lose out on an opportunity to sell additional product or services to other runner up bidders who had indicated interest in purchasing the product or service.

In reverse style auctions, individual consumers place specific individual bids on a product or service that make up an individual auction with the primary objective to drive purchase prices downward and give perspective buyers a chance to find the lowest-price supplier. If a bid matches or exceeds the hidden price target specified in advance by the vendors, the consumer instantly wins the auction. If a consumer bids less than the trigger value even by a small amount, for example $1, they do not win the auction. For example, if one bidder offers $101 and the second bidder separately offers a separate bid of $99 for a product or service with a $100 sales trigger price, only the $101 bid wins and the vendor loses out on maximizing their volume of two sales to multiple bidders.

In Dutch style auctions, the product or service being sold is initially offered at a very high price, well in excess of the amount the seller expects to receive. The price is lowered in decrements until a bidder accepts the current price. That bidder wins the auction and pays that price for the item. For example, if an auction for a car is started at $15,000, the bidders will wait as the price is successively reduced to $14,000, $13,000, $12,000, $11,000 and $10,000. When the price reaches $10,000, if one perspective buyer decides to accept that price, they win the auction and have to pay $10,000 for the car because they were the first bidder to accept the price. This sales format is not conducive to selling more than one product or service.

In first-price sealed-bid style auctions all perspective buyers simultaneously submit one sealed offer each so that no bidder knows the bid of any other participant. The highest bidder pays the price they submitted. This sales format is not conducive to selling more than one product or service unit.

In Vickrey style auctions, all perspective buyers simultaneously submit one sealed offer each so that no bidder knows the bid of any other participant. The highest bidder pays the price the second highest bidder submitted. This sales format is not conducive to selling more than one product or service unit.

In uniform price style auctions, a fixed number of identical units of a product or services are sold for the same price. Each bidder in the auction may submit one or more bids, designating both the quantity of units desired and the price they are willing to pay per unit. The auctioneer then serves the highest bidder first, giving them the number of units requested, then the second highest bidder and so forth until the supply of the commodity is exhausted. All bidders then pay a per unit price equal to the lowest winning bid. This sales format is conducive to selling a quantity of product or services but is not conducive to maximizing revenue based on offers submitted by perspective buyers.

In all-pay auctions, all perspective buyers who submit bids must pay their bids regardless of whether they win. The highest bidder wins the item. This sales model is not conducive to selling volume of a product or service but may maximize revenue dependent on the number of bidders and the value of their bids.

In bidding fee auctions, each perspective buyer must purchase the right to place a set number of bids prior to placing them. When an auction's time expires, the last bidder wins the item and must pay a final bid price. This sales format is not conducive to selling volume of a product or service but may maximize revenue dependent on the number of bidders and the number of bid rights they've purchased.

Additional retailing and auction formats exist, however, all of them have one or more of the deficiencies outlined above—namely none of them are conducive to selling volume of an identical or substantially identical product or service and maximize revenue in a single offering.

There is currently no system made available for use by vendors to produce a single offering that maximizes a volume of sales of a fixed number of identical or substantially identical units of a product or service and maximizes revenue based on all consumer interest in a product or service regardless of whether offers are submitted at varying price levels and whether a bid falls below a specified sales price.

### SUMMARY OF THE INVENTION

Accordingly, computer-implemented methods and systems of providing a volume and revenue maximizing retail sales platform is provided. In one example embodiment, a method according to the invention, includes transmitting, by a network server, one or more sales offerings of one or more comparable items associated with a vendor or vendors to a plurality of potential buyers. In some embodiments, the method includes receiving, via the network server, at least one respective purchase offer, for at least one of the one or more comparable items, from each of a plurality of interested buyers during a sales offer period. In some embodiments, the method includes determining, by an application computer processor, a first average purchase offer comprising an average of at least a portion of the plurality of purchase offers received from the network server.

In some embodiments, the method includes comparing, by the application computer processor, the first average purchase offer with a sales trigger price associated with the vendor or vendors. In some embodiments, the method includes executing, by the application computer processor, a sale to each interested buyer whose purchase offer was included in the determination of the first average purchase offer when the first average purchase offer is within a predefined range associated with the sales trigger price, and when a first predefined volume of purchase offers have been received.

In some embodiments, the method further includes, when the first average purchase offer is not within the predefined range associated with the sales trigger price, determining, by the application computer processor, a second average purchase offer comprising an average of the portion of the plurality of purchase offers considered in the determination of the first average purchase offer excluding one or more previously considered purchase offers. In some embodiments, the method further includes comparing, by the application computer processor, the second average purchase offer with the sales trigger price associated with the vendor or vendors. In some embodiments, the method further includes executing, by the application computer processor, a sale to each interested buyer whose purchase offer was included in the determination of the second average purchase offer when the second average purchase offer is within the predefined range associated with the sales trigger price, and when the first predefined volume of purchase offers have been received.

In some embodiments of the method, the predefined range associated with the sales trigger price includes a set of all values equal to or greater than the sales trigger price. In some embodiments of the method, the one or more previously considered purchase offer that is excluded is the lowest remaining previously considered purchase offer.

In some embodiments, the method further includes transmitting, by the network server, one or more communications to each interested buyer whose purchase offer was included in the determination of the first average purchase offer but excluded from the determination of the second average purchase offer, and whose purchase offer is not within the range associated with the sales trigger price. In some embodiments, the one or more communications includes one or more of an amount by which each interested buyer would be required to raise their offer to meet the first average purchase offer, the sales trigger price, the retail price, any other predefined price or price range, a revised offer, and/or a request for another bid without specifying a suggested price or price range.

In some embodiments, the method further includes executing, by the application computer processor, a sale to each interested buyer whose purchase offer was not included in the determination of the of the first average purchase offer but whose purchase offer is within the predefined range associated with the sales trigger price.

In some embodiments, the method further includes transmitting, by the network server, one or more communications to each interested buyer whose purchase offer was not included in the determination of the first average purchase offer and whose purchase offer is not within the range associated with the at least one sales trigger price. In some embodiments of the method, the one or more communications includes one or more of an amount by which each interested buyer would be required to raise their offer to meet the first average purchase offer, the sales trigger price, the retail price, any other predefined price or price range, a revised offer, and/or request for another bid without specifying a suggested price or price range.

In some embodiments of the method, the sales offer period is a vendor selected offer period. In some embodiments, the method further includes when the number of received purchase offers exceeds the number of available one or more comparable items, executing, by the application computer processor, sales based on at least one of a first-in-time rule and a highest purchase offer rule. In some embodiments of the method, the one or more comparable items includes one or more products and/or services.

In some embodiments of the method, one or more of the steps of determining the first average purchase offer, comparing the first average purchase offer with the sales trigger price set by the vendor or vendors, and executing the sale to each interested buyer whose purchase offer was included in the determination of the first average purchase offer, occurs in real time as purchase offers are received, at a predefined time or interval during the sales offer period, and/or at the end of the sales offer period. In some embodiments, the method further includes adjusting, by the application computer processor, the sales trigger price, in real time and/or at the end of the sales offer period, responsive to a request associated with a vendor, a predefined change in circumstances, and/or at least a second predefined volume of received purchase offers.

In some embodiments, the method further includes, when the first predefined volume of purchase offers have been received, but the first average purchase offer is not within the predefined range associated with the sales trigger price, executing, by the application computer processor, a sale to each interested buyer whose purchase offer is within the range associated with the sales trigger price, in real time as purchase offers are received, at a predefined time or interval during the sales offer period, and/or at the end of the sales offer period.

In some embodiments, the method further includes transmitting, by the network server, one or more communications to each interested buyer whose purchase offer was included in the determination of the first average purchase offer and whose purchase offer is not within the predefined range associated with the sales trigger price. In some embodiments, the communication comprises one or more of an amount by which each interested buyer would be required to raise their offer to meet the first average purchase offer, the sales trigger price, the retail price, any other predefined price or price range, a revised offer, and/or request for another bid without specifying a suggested price or price range. In some embodiments, the method further includes, when the number of received purchase offers exceeds the number of available one or more comparable items, aggregating, by the application computer processor, one or more additional comparable items associated with one or more additional vendors, and executing, by the application computer processor, sales based on a first-in-time rule and/or a highest purchase offer rule.

In another example embodiment, a computer-implemented system for providing a volume and revenue maximizing retail sales platform is provided. In some embodiments, the system includes a network server, configured to transmit sales offering of one or more comparable items associated with one or more vendors to a plurality of potential buyers, and to receive at least one respective purchase offer, for one or more of the one or more comparable items, from each of a plurality of interested buyers during a sales offer period.

In some embodiments, the system further includes an application computer processor configured to determine a first average purchase offer comprising an average of at least a portion of the plurality of purchase offers received from the network server. In some embodiments, the application computer processor is configured to compare the first average purchase offer with a sales trigger price associated with the one or more vendors. In some embodiments, the application computer processor is configured to execute a sale to each interested buyer whose purchase offer was included in the determination of the first average purchase offer when the first average purchase offer is within a predefined range associated with the sales trigger price, and when a first predefined volume of purchase offers have been received. In some embodiments of the system, the predefined range associated with the sales trigger price comprises a set of all values equal to and/or greater than the at least one sales trigger price.

In yet another example embodiment, a computer-implemented method of providing a volume and revenue maximizing retail sales platform is provided. In some embodiments, the method includes transmitting, by a network server, one or more sales offerings of one or more comparable items associated with one or more vendors to one or more buyers. In some embodiments, the method includes receiving, via the network server, one or more respective purchase offers, for one or more of the one or more comparable items, from the one or more buyers. In some embodiments, the method includes determining, by an application computer processor, an average purchase offer comprising an average of at least a portion of the purchase offers received from the network. In some embodiments, the method includes comparing, by the application computer processor, the average purchase offer with a sales trigger price associated with the one or more vendors. In some embodiments, the method includes executing, by the application computer processor, a sale to the one or more buyers when the average purchase offer is within a predefined range associated with the at least one sales trigger price.

In some embodiments of the method, the predefined range associated with the at least one sales trigger price comprises a set of all values equal to and/or greater than the at least one sales trigger price. In some embodiments, the method further includes, when the number of received purchase offers exceeds the number of available one or more comparable items, aggregating, by the application computer processor, one or more additional comparable items associated one or more additional vendors. In some embodiments, the method further includes, executing, by the application computer processor, sales based on a first-in-time rule and/or a highest purchase offer rule.

### BRIEF DESCRIPTION OF THE DRAWINGS

The foregoing summary, including the above and other features and advantages of the innovative retailing system and method, as well as a brief description of the preferred embodiments of the application will be better understood when read in conjunction with the appended drawings. For the purpose of illustrating the preferred embodiments of the present inventions, and to explain their operation, drawings of preferred embodiments and schematic illustrations are shown. It should be understood, however, that the application is not limited to the precise arrangements, variants, structures, features, embodiments, aspects, methods, advantages and instrumentalities shown, and the arrangements, variants, structures, features, embodiments, aspects, methods, advantages, improvements and instrumentalities shown and/or described may be used singularly in the system or method or may be used in combination with other arrangements, variants, structures, features, embodiments, aspects, methods, advantages, improvements and instrumentalities. In the drawings:

FIG. 1 is a flow diagram of a method according to some embodiments of the invention.

FIG. 2 is a generalized schematic diagram of a representative system on which an interactive user display application may be implemented in accordance with some embodiments of the invention.

FIG. 3 is a schematic of the system of FIG. 2 depicting in more detail the server and computing device in accordance with some embodiments of the invention.

FIG. 4 illustratively depicts an exemplary diagram of a computer system utilizable for employing the methods and systems of the invention in accordance with some embodiments of the invention; and

FIG. 5 illustratively depicts an exemplary block diagram of the internal hardware of the exemplary computer system of FIG. 4 in accordance with some embodiments of the invention.

### DETAILED DESCRIPTION OF THE INVENTION

The following description includes many specific details. The inclusion of such details is for the purpose of illustration only and should not be understood to limit the invention. Moreover, certain features which are well known in the art are not described in detail in order to avoid complication of the subject matter of the present invention. In addition, it will be understood that features in one embodiment may be combined with features in other embodiments of the invention to form yet other embodiments.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

Various embodiments of this invention relate to systems and methods for increasing the volume of sales transactions between one or more vendors and one or more buyers in a sales offering including one or more identical or substantially identical products or sets of products and/or services that are limited in quantity within a specified time period. In some embodiments, instead of or in addition to, aggregating buyers, sellers may optionally be aggregated to enhance the possibility of maximizing sales to one or more buyers. For example, sellers with different profits/retail prices can be aggregated to lower prices to buyers in order to increase sales. Such aggregation can be, for example, ad hoc, or with pre-defined seller groups. In either case, should a seller receive more bids than the quantity of a product in stock or than the maximum manpower or available time and/or resources for a service, a seller can aggregate other sellers in a similar manner to maximize on sales, regardless of the individual sellers' prices.

In some embodiments, a sales offering of one or more identical, comparable and/or substantially identical consumer products (i.e. automobile, laptop computer, television, coat, telephone, vacation package, gift certificate) is provided. This invention may also be used for sales offerings including consumer services such as dry cleaning, internet access, telephone services, commercial products such as steel, plastics and aluminum, corporate services such as advertising solutions. The invention is not limited only to sales offerings of consumer products and can be used in connection with the sale of any products and/or services that are identical, substantially identical, similar and/or otherwise comparable. The term substantially identical is used herein to connote products and/or services that are similar and/or comparable such that the potential buyer will view the products and/or services as substantially the same and/or of substantially similar value and/or use.

For example, substantially identical products may include two products with similar specifications, where one product may be made in China and a second product may be made in Taiwan. On the other hand, products that might not be considered substantially identical if one product is made in Korea and the other product is made in the United States. By way of another example, tickets representing seating at a concert or on an airplane or other vehicle may represent seats located in different areas but having substantially similar values/designations (e.g., “orchestra,” “balcony,” “aisle,” or “window,” etc.)

Alternatively, products and/or services may be considered substantially identical or similar if the warranty provisions are comparable. The term comparable as used herein may refer to two or more products and/or services that are sufficiently identical, substantial identical, similar, and/or substantially similar, such that one product or service could legitimately be substituted for or replaced by the other. These and other embodiments are provided for illustration of the invention and not to limit it to a particular vendor type and/or commodity. In some embodiments, products and/or services may also be considered to have substantially similar value despite having dissimilarities. For example, tickets in the back row of the “orchestra” section of a concert hall may have substantially similar value to the front row of the “balcony” section above.

As used herein, in some embodiments, a “sales offering” may refer to an offer by a seller which can be accepted by a buyer. In some embodiments, a “sales offering” may refer to a request for offers to sell a product or service at a particular offered purchase price. Such an offered purchase price can then be accepted by the Seller, either automatically when certain conditions are met, or manually. In some embodiments, the terms “bid” and “offer” may be used to described these and others commonly understood definitions.

It should also be noted that although some embodiments of the invention relate to a sales offering of a single vendor to one or more buyers in a sales offering including one or more identical or substantially similar consumer products, such as a television, these embodiments are not limited to one sales offering per vendor or a single vendor. Rather, this invention may be applied to a single vendor that conducts more than one sales offering simultaneously, or a single vendor that conducts sale offerings on a periodic or ongoing basis. Additionally or alternatively, in some embodiments, multiple vendors may be aggregated as described above, to increase sales and maximize profit.

In some embodiments, a buyer purchases a product based on a price set by the vendor, or in some cases, such as in proxy bid style auctions, based on the highest price the buyer is willing to pay for the product. In either of these examples, quantity sold is equal to the number of offers to purchase the available product at a price equal to or greater than the sales trigger price set by the vendor.

As used herein, the average offer price is an average of multiple prices offered by one or more buyers on one or more comparable items. In some embodiments, prices other than average prices may be used. In some embodiments, average can refer to the arithmetic “mean,” whereby a set of numbers are added together, and the total is divided by the amount of numbers in the set. In some embodiments, average can refer to the arithmetic “median” which reflects the “middle” value in a set of numbers when the numbers are in numerical order, or the mean of the middle two numbers when there are an even amount of numbers in a set. In some embodiments, average can refer to the “mode,” which is the value that occurs the most often in a set of numbers. When more than one mode exists, one may be selected based on other considerations, or the mean of the modes can be calculated. Other definitions of average may also be employed as desired.

In some embodiments, a vendor selects a product, set of products, service, and/or set of services, sets at least one sales trigger price—e.g., the minimum price at which a transaction can occur, and/or sets a sales offer period. In other embodiments, vendors can set a minimum sales quantity as a requirement for the average offer price to be accepted. In some embodiments, multiple sales trigger prices may be set, for example, in accordance with multiple sales quantity thresholds, or multiple times or time intervals. By using the systems and methods described in this invention, quantity sold may be equalized to the number of offers to purchase the available product whose average offer price is equal to or greater than the sales trigger price set by the vendor. Although there may be a pre-set sales offer period, in some embodiments, the average offer price may be calculated in real time. In some embodiments, once the average offer price for the quantity of product available for sale matches or exceeds the sales trigger price, a sales transaction occurs. In some embodiments, the vendor can adjust the sales trigger price and/or minimum sales quantity in real time depending, for example, on the level of interest of buyers and/or changing circumstances. In some embodiments, the level of interest of buyers may be reflected by the volume of offers received, independent data, and/or requests for additional information regarding a product, service, and/or the sale itself.

In some embodiments, a sales transaction using an average offer price may be calculated, for example, using the following algorithm executed on a programmable computer system:

$${\sum }_{j = 1}^{n} V ( Pj ) / Min [ n , m ] \geq TP$$

n=number of bids submitted thus far

m=quantity of available sales items, e.g. number of toothbrushes for sale, or service available

Pj=price submitted by bid j, j=1 to n

TP=trigger price

$$\begin{matrix}V ( Pj ) = Value function for bid j submitted \text{:} \\ = 0 if R [ Pj ] > m \\ = Pj if R [ Pj ] \leq m\end{matrix}$$

R[Pj]=rank of price of bid j, where the highest bid is 1 and the lowest bid is m. If two or more bids are of the same size, then they are optionally ordered according to the time they were made, (first in time), where the earlier one gets the lower rank.

In some embodiments, if the pre-set sales offer period expires with fewer offers than the quantity of product available, the average offer price is compared to the trigger price upon expiration of the sales offer period, and if the average offer price reaches or exceeds the sales trigger price, a sales transaction occurs for the number of products equal to the total number of offers. In some embodiments, if the average offer price falls below the sales trigger price, either regardless of the number of offers submitted, or when a certain volume of offers have been submitted, offers at or above the sales trigger price are accepted and a sales transaction occurs for a quantity equal to offers at or above the sales trigger price. Buyers whose offer prices were below the sales trigger price are optionally sent a follow-up sales offer by email or any other form of communication, such as a notice of rejection, or additional information.

In other embodiments, although the average offer price is calculated in real time, purchase offers are accepted during the entire pre-set sales offer period, even if the average offer price for the quantity of product available for sale matches or exceeds the sales trigger price, to determine if the average offer price might exceed the sales trigger price.

In yet other embodiments, if a pre-set sales offer period expires and the average offer price is below the sales trigger price, the system calculates a revised average offer price by removing the lowest bids incrementally or otherwise as necessary, until a revised average offer price that reaches or exceeds the sales trigger price is determined, at which point a sales transaction occurs for the quantity of offers that made up the revised average offer price. In these and other embodiments, the system would line up the bids according to declining size such that P′j is the mapped price in size from Pj. The system would run for k from 1 to Min(m,n) and each time test, for example, the following formula, stop at k and use P′j. Once the condition is met, a sales transaction is created for all offers P′j up to k−1.

This may be calculated, for example, using the following algorithm executed on a programmable computer system:

$$• {\sum }_{j = 1}^{k} {P}^{′} j / k < TP$$

In these and other embodiments, buyers whose offer prices were not included in the revised average offer price are optionally sent a follow-up sales offer by email or any other form of communication. Such an offer may optionally include, for example, an amount by which each buyer would be required to raise their offer to meet the average offer price, the trigger price, the retail price, or any other price or price range set by the seller. In other embodiments, the follow-up sales offer may simply request another bid without specifying a suggested price or price range.

In some embodiments, a vendor such as a manufacturer, wholesaler, broker, retailer and/or liquidator, may want to employ the systems and methods according to the present invention to sell a greater volume of product. In yet other embodiments, buyers may want to employ the systems and methods according to some embodiments of the invention as a “buyer opt-in” format, wherein buyers form buyer groups by offering unspecified amounts, and upon reaching the seller's sales trigger price, causing a sales transaction with the seller.

It should be noted that the present invention is primarily described herein in terms of an electronic application, executed, for example, by an application computers processor; However, the present invention is not limited to an electronic application and in some embodiments may be implemented on other platforms. It will be understood by those of ordinary skill in the arts that the application may be any suitable software, hardware or both configured to implement the features of the present invention, e.g. servers, networks, personal computing devices, etc. The application may be implemented on any suitable platform (i.e. personal computer, laptop computer, touch pad computer, tablet, smartphone, multimedia device, or on any other device) to provide such features for a variety of users and uses including, but not limited to, public auctions, public sales, private auctions, private sales, daily deal sales, mobile e-commerce sales, mobile auctions, Facebook e-commerce sales, Facebook auctions, social media e-commerce sales, social media auctions, SMS e-commerce sales, SMS auctions, television, radio or Internet/web infomercial telephone sales, television, radio or Internet/web infomercial e-commerce sales, multi-level marketing e-commerce sales, television game shows, reality television shows, skill contests, sweepstakes, lotteries and other games of chance, casino style gaming, board games, electronic games (handheld or otherwise), computer software applications (games or otherwise), and/or mobile or handheld device software applications (games or otherwise).

In some embodiments, the electronics sales application may be located in a central location (e.g. a central server and/or mainframe). In another suitable approach, the electronic application may reside among different locations (i.e. multiple servers and/or computing devices on a network). In some embodiments, the electronic application may include client side software, hardware, or both, for example one or more web pages, web page portions, GUI's, etc.

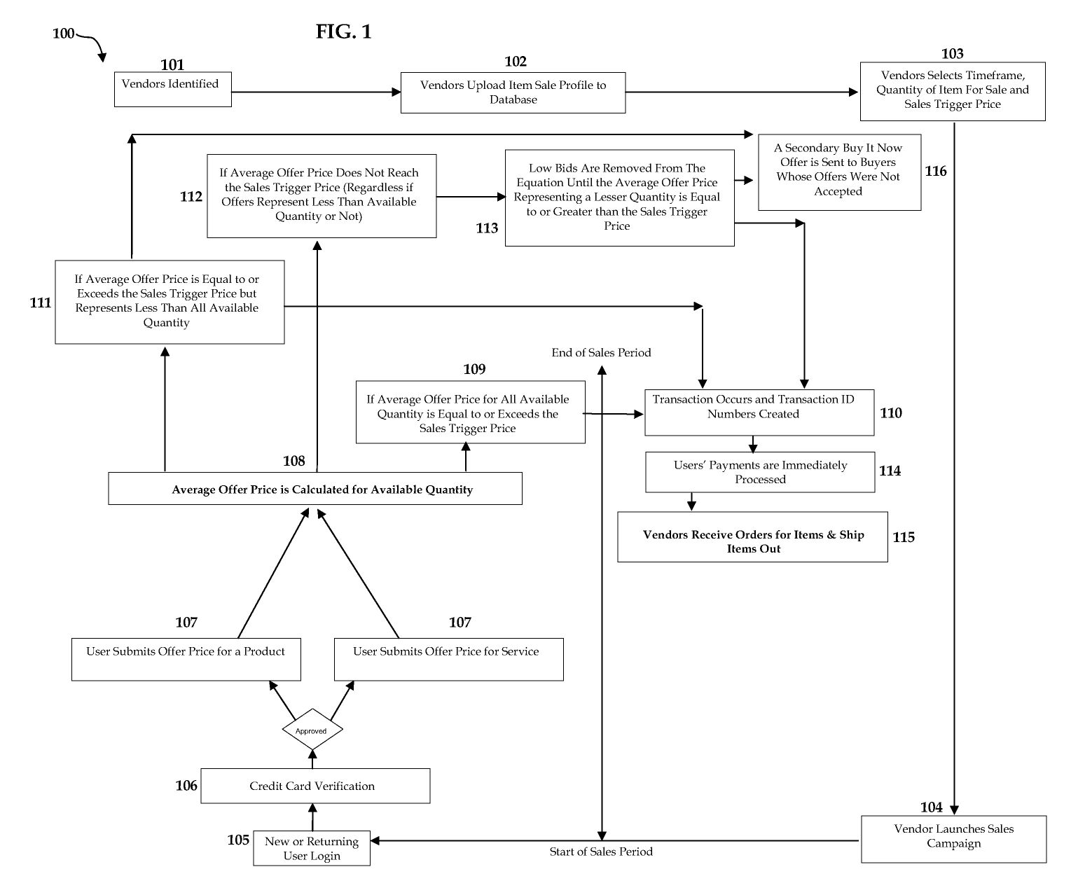

FIG. 1 illustrates a diagram chart 100 in accordance with some embodiments of the present invention. It should again be noted that while the embodiment of the flow diagram of FIG. 1 outlines a method comprising elements of above embodiments described above, these designations are merely exemplary. As shown in FIG. 1, at step 101 a vendor is selected for participation in a sale offering of one or more comparable, identical or substantially identical products and/or services. In some embodiments, vendors may be able to “opt-in” without being selected, for example, in a buyer group situation as described above, and/or in a situation where vendors are aggregated to compete purchase orders. In some embodiments, some or all vendors may be “pre-approved” based on certain predefined criteria. In yet other embodiments some vendors may be required to be selected, while others may be able to opt-in.

The vendor may be any individual or entity that provides goods and/or services to a consumer, a business and/or an organization. The vendor may be local, national or global in terms of the geography the vendor provides the goods or services in and the vendor may be solicited for the system or may hear of the system and may approach the system's provider without being solicited. In some embodiments, a vendor such as a manufacturer, wholesaler, broker, retailer or liquidator, may want to employ the systems and methods according to the present invention to sell a greater volume of product. In yet other embodiments, buyers may want to employ the systems and methods according to some embodiments of the present invention as a “buyer opt-in” format, wherein buyers form buyer groups by offering unspecified amounts, and upon reaching the seller's sales trigger price, causing a sales transaction with the seller.

At step 102, a product, sets of products, and/or service(s) is identified by the vendor, and a profile of the item for sale is uploaded to a product database. The good(s) may be any product sold and/or distributed, and the service(s) can be any services provided by the vendor or a third party on behalf of the vendor. In some embodiments, a sales offering of one or more comparable, identical, substantially identical, and/or similar consumer products (i.e. automobile, laptop computer, television, coat, telephone, vacation package, gift certificate) is provided. This invention may also be used for sales offerings including consumer services such as dry cleaning, internet access, telephone services, commercial products such as steel, plastics and aluminum, corporate services such as advertising solutions, etc. The invention is not limited only to sales offerings of consumer products and can be used in connection with the sale of any products and/or services that are comparable, identical, substantially identical and/or similar.

The term substantially identical is used herein to connote products and/or services that are similar such that the potential buyer will view the products and/or services as substantially the same or of substantially similar value. For example, substantially identical products may include two products with similar specifications, where one product may be made in China and a second product may be made in Taiwan. On the other hand, products that might not be considered substantially identical if one product is made in Korea and the other product is made in the United States. By way of another example, tickets representing seating at a concert or on an airplane or other vehicle may represent seats located in different areas but having substantially similar values/designations (e.g., “orchestra,” “balcony,” “aisle,” or “window,” etc.)

Additionally and/or alternatively, products and/or services may be considered comparable, substantially identical, or similar if the warranty provisions are comparable. These embodiments are provided for illustration of the invention and not to limit it to a particular vendor type and/or commodity. Products and/or services may also be considered to have substantially similar value despite having dissimilarities. For example, tickets in the back row of the “orchestra” section of a concert hall may have substantially similar value to the front row or the “balcony” section above.

Details of the sales offering are then determined at step 103, when the vendor selects, for example, a sales offer period comprising a timeframe for the sale offering, a quantity of the item to be sold, and/or a sales trigger price. A timeframe for the sale offering may include a discrete sales offer period, for example one week, one month, a specific number of hours, and/or may be defined by a particular start and/or end date. Additionally or alternative, a timeframe may be “while supplies last,” or may be tied to the occurrence of particular defined events. In some embodiments, a timeframe may be defined as a single offer period (e.g., a “one day” sale), or recurring offer periods (e.g., a service provided every other weekend for three months). For the sale of goods, in some embodiments, a quantity of the item to be sold may be a number of individual items, a number of batches or crates of items, etc. For the sale of services, in some embodiments, quantity of the item to be sold may refer to the number of hours of service/labor to be provided, the number of times a service will be provided, etc.

A sales trigger price may be defined, in some embodiments, as the minimum price at which a transaction can occur. In some embodiments, this can be calculated by setting a minimum sales quantity as a requirement for the average offer price to be achieved in order for a transaction to occur. Typically the vendor sets the sales offer period, minimum sales quantity and/or the sales trigger price. However, in some embodiments any or all of these can be determined by a third party, such as, for example, a third party consulting firm, or by a government regulation/entity, etc.

The sales offering is then launched at step 104 to start the sales offer period, for example through a website on the Internet, or via an application on a network enabled computing device. In some embodiments, the sales offer information on the website or application may include the product or service description, such as for example a title or name, brand, supplier and/or service provider information, product and/or service specifications, product SKU number, terms, conditions, and/or restrictions, pictures and/or video representing the brand, product and/or service, retail price suggested by the brand, vendor and/or a third party for the product or service, timeframe for the sales offering and/or quantity of product or service units available for sale. Further, the website may also include information about the number of bids submitted by perspective buyers and/or shipping costs, if applicable. The website would not display the sales trigger price to perspective buyers.

It should be noted that the present invention is primarily described herein in terms of an electronic application, however, the present invention is not limited to an electronic application and may be implemented on other platforms. It will be understood by those of ordinary skill in the arts that the application may be any suitable software, hardware or both configured to implement the features of the present invention. The application may be implemented on any suitable platform (i.e. personal computer, laptop computer, touch pad computer, tablet, smartphone, multimedia device, or on any other device) to provide such features for a variety of uses including but not limited to public auctions, public sales, private auctions, private sales, daily deal sales, mobile e-commerce sales, mobile auctions, Facebook e-commerce sales, Facebook auctions, social media e-commerce sales, social media auctions, SMS e-commerce sales, SMS auctions, television, radio or Internet/web infomercial telephone sales, television, radio or Internet/web infomercial e-commerce sales, multi-level marketing e-commerce sales, television game shows, reality television shows, skill contests, sweepstakes, lotteries and other games of chance, casino style gaming, board games, electronic games (handheld or otherwise), computer software applications (games or otherwise) and/or mobile or handheld device software applications (games or otherwise).

In some embodiments, the electronics sales application may be located in a central location (i.e. a mainframe and/or central server). In another suitable approach, the electronic application may reside among different locations e.g. multiple network-enabled computers, servers, applications, etc.). In some embodiments, the electronic application may include client side software, hardware, or both, for example one or more web pages, web page portions, and/or applications resident on computing devices.

At step 105, perspective buyers initiate participation in a sales offering by signing in to the website with login information such as a user name and password. In some embodiments, signing up to obtain login information may entail providing the name of the perspective buyer, email address of the perspective buyer, physical address of the perspective buyer, telephone number of the perspective buyer and/or any other specified identification information. This information may be stored, for example, in a database connected to the website. Buyers who previously obtained login information may not be required to create a new account each time they log in, but may be asked additional security questions. In other embodiments, perspective buyers may also sign up to the website using login information of third party platforms, such as, for example, a Facebook, Twitter, or Gmail user name and password, that are integrated into the website using, for example, APIs. In some embodiments, at step 106, perspective buyers may also be required to provide validated payment instrument information such as a credit card number, expiration date, and security code in advance of participating in the sales offering.

At step 107, perspective buyers then submit their highest offer price for quantity of one or more of a product and/or service. In some embodiments, perspective buyers may increase their offer price for each unit of quantity at separate times increments, and/or intervals. For example, if a perspective buyer is submitting an offer for a quantity of one unit, the first offer can be made at a price of $100, the second at $105 and the third at $110. In other embodiments, perspective buyers may submit multiple offers of varying prices for each additional unit of quantity at separate times. For example, if a perspective buyer is submitting an offer for a quantity of three units of quantity, the first offer representing one unit can be made at a price of $100, the second offer representing the second unit of quantity can be made at $105 and the third offer representing the third unit of quantity can be made at $110.

At step 108, an average offer price is calculated, averaging multiple prices offered by one or more buyers, on one or more comparable, identical, substantially identical, and/or similar items, based on the available quantity. In some embodiments, prices other than average offer prices may be used.

Although in some embodiments, there is a pre-set sales offer period, in some embodiments, the average offer price may be calculated in real time as purchase offers are received from prospective buyers. In some embodiments, once the average offer price for the quantity of product available for sale matches or exceeds the sales trigger price at step 109, a sales transaction occurs at step 110 and a transaction ID number is optionally created. In some embodiments, the vendor can adjust the sales trigger price or minimum sales quantity in real time depending, for example, on the level of interest of buyers or changing circumstances.

A sales transaction using an average offer price may be calculated, for example, using the following algorithm executed on a programmable computer system:

$${\sum }_{j = 1}^{n} V ( Pj ) / Min [ n , m ] \geq TP$$

n=number of bids submitted thus far

m=quantity of available sales items

Pj=price submitted by bid j, j=1 to n

TP=trigger price

$$\begin{matrix}V ( Pj ) = value function for bid j submitted \text{:} \\ = 0 if R [ Pj ] > m \\ = Pj if R [ Pj ] \geq m\end{matrix}$$

R[Pj]=rank of price of bid j, where the highest bid is 1 and the lowest bid is m. If two or more bids are of the same size, then they are optionally ordered according to the time they were made, where the earlier one gets the lower rank.

In other embodiments, although the average offer price may be calculated in real time, purchase offers are accepted during the entire pre-set sales offer period, even if the average offer price for the quantity of product available for sale matches or exceeds the sales trigger price, to determine if the average offer price might exceed the sales trigger price. In some embodiments, the average offer price is calculated at the end of the sales offer period.

In some embodiments, if the pre-set sales offer period expires with fewer offers than the quantity of product available, at step 111 the average offer price is compared to the trigger price upon expiration of the sales offer period, and if the average offer price reaches or exceeds the sales trigger price, a sales transaction occurs for the number of products equal to the total number of offers. In other embodiments, if the average offer price falls below the sales trigger price, regardless of the number of offers submitted, offers at or above the sales trigger price are accepted, and a sales transaction occurs for a quantity equal to offers at or above the sales trigger price. In some embodiments, buyers whose purchase offers were not executed may be contacted with a revised offer and/or other relevant communications at step 116.

In yet another embodiment, if the pre-set sales offer period expires and the average offer price is below the sales trigger price at step 112, then the system calculates a revised average offer price by removing the lowest bids incrementally or as otherwise necessary until a revised average offer price that reaches or exceeds the sales trigger price is determined, at which point a sales transaction occurs for the quantity of offers that made up the revised average offer price at step 113. In these and other embodiments, the system would line up the bids according to declining size such that P′j is the mapped price in size from Pj. The system would run for k from 1 to Min(m,n) and each time test, for example, the following formula, stop at k and use P′j. Once the condition is met, a sales transaction is created for all offers P′j up to k−1.

In some embodiments, this may be calculated, for example, using the following algorithm executed on a programmable computer system:

$$• {\sum }_{j = 1}^{k} {P}^{′} j / k < TP$$

At step 114, each buyer's validated payment instrument such, as a credit card or bank account is charged or debited and the vendor receives order information for the products or services for each buyer. At step 115, the buyers or their assignees receive delivery of the product or service from the vendor or a third party. In some embodiments, the actual item (product or service) may be delivered directly to the buyer or a buyer's assignee. In other embodiments, a certificate may be delivered to a buyer or a buyer's assignee electronically or by mail which may be used to redeem and obtain a product or service at an assigned location and/or time. Validated payment information belonging to perspective buyers who were not successful in purchasing the available product or service is not charged.

At step 116, perspective buyers whose offer prices were not included in the average offer price may be sent a follow-up sales offer by email or any other form of communication. Such an offer may optionally include, for example, an amount by which each buyer would be required to raise their offer to meet the average average price, the trigger price, the retail price, or any other price or price range set by the seller. In other embodiments, the follow-up sales offer may simply request another bid without specifying a suggested price or price range.

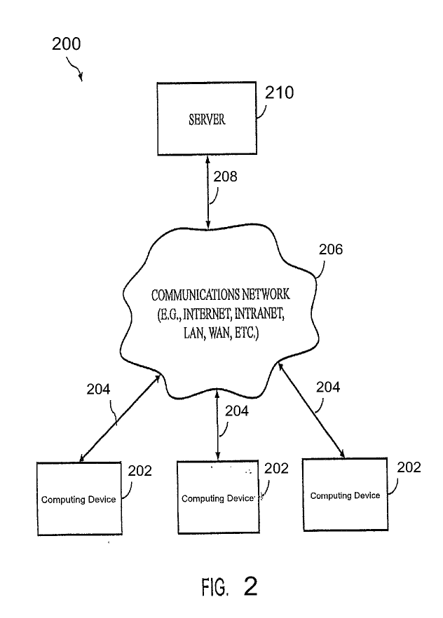

FIG. 2 is a generalized schematic diagram of a system 200 on which an interactive user display application may be implemented in accordance with some embodiments of the present invention. As illustrated, system 200 may include one or more user computing devices 202. User computing devices 202 may be local to each other or remote from each other, and wired, wireless, or a combination of both. User computing devices 202 are connected by one or more communications links 204 to a communications network 206 that is linked via a communications link 208 to a server 210.

System 200 may include one or more servers 210. Server 210 may be any suitable server for providing access to the application, such as a processor, a computer, a data processing device, or a combination of such devices. Communications network 206 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 204 and 208 may be any communications links suitable for communicating data between user computing devices 202 and server 210, such as network links, dial-up links, wireless links, hard-wired links, any other suitable communications links, or a combination of such links. User computing devices 202 enable a user to access features of the application. User computing devices 202 may be personal computers, laptop computers, mainframe computers, dumb terminals, data displays, Internet browsers, personal digital assistants (“PDAs”), smartphones, tablets, multimedia devices, two-way pagers, wireless terminals, cellular phones, portable telephones, handheld devices, any other suitable access device, or any combination of such devices. User computing devices 202 and server 210 may be located at any suitable location. In one embodiment, user computing devices 202 and server 210 may be located within an organization/entity. Alternatively, user computing devices 202 and server 210 may be distributed between multiple organizations/entities.

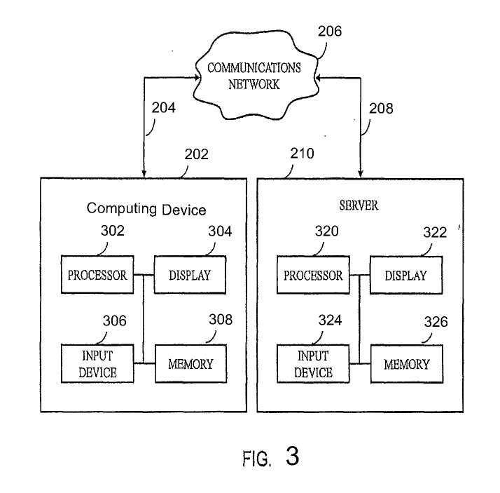

A server and a user computing device, such as those depicted in FIG. 2, are illustrated in more detail in FIG. 3. Referring to FIG. 3, computing device 202 may include processor 302, display 304, input device 306, and memory 308, which may be interconnected. In a preferred embodiment, memory 308 contains a storage device (not shown) for storing a program for controlling processor 302.

Processor 302 uses the program to present on display 304 the application and the data received through communications link 204 and commands and values transmitted by a user of computing device 202. It should also be noted that data received through communications link 204 or any other communications links may be received from any suitable source. Input device 306 may be a computer or device keyboard, a cursor-controller, dial, switchbank, lever, button, or any other suitable input device as would be used by a designer of input systems or process control systems. In some embodiments, input device 306 may be any device with a Musical Instrument Digital Interface (MIDI), which enables, computers, and other suitable equipment to communicate, control, and synchronize with each other.

Server 210 may include processor 320, display 322, input device 324, and memory 326, which may be interconnected. In a preferred embodiment, memory 326 contains a storage device (not shown) for storing data received through communications link 208 or through other links, and also receives commands and values transmitted by one or more users. The storage device further contains a server program for controlling processor 320.

In some embodiments, the application may include an application program interface (not shown), or alternatively, the application may be resident in the memory of computing device 202 or server 210. In another suitable embodiment, the only distribution to computing device 202 may be a graphical user interface (“GUI”) which allows a user to interact with the application resident at, for example, server 210.

In some embodiments, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

Although the application is described herein as being implemented on a computing device and/or server, this is only illustrative. The application may be implemented on any suitable platform, e.g., a personal computer (“PC”), a mainframe computer, a dumb terminal, a data display, a two-way pager, a wireless terminal, a portable telephone, a portable computer, an automobile PC, a laptop computer, tablet, multimedia device, a cellular phone, a personal digital assistant (“PDA”), smartphone, etc., to provide such features.

It will also be understood that the detailed description herein may be presented in terms of program procedures executed on a computing device or network of computing devices. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

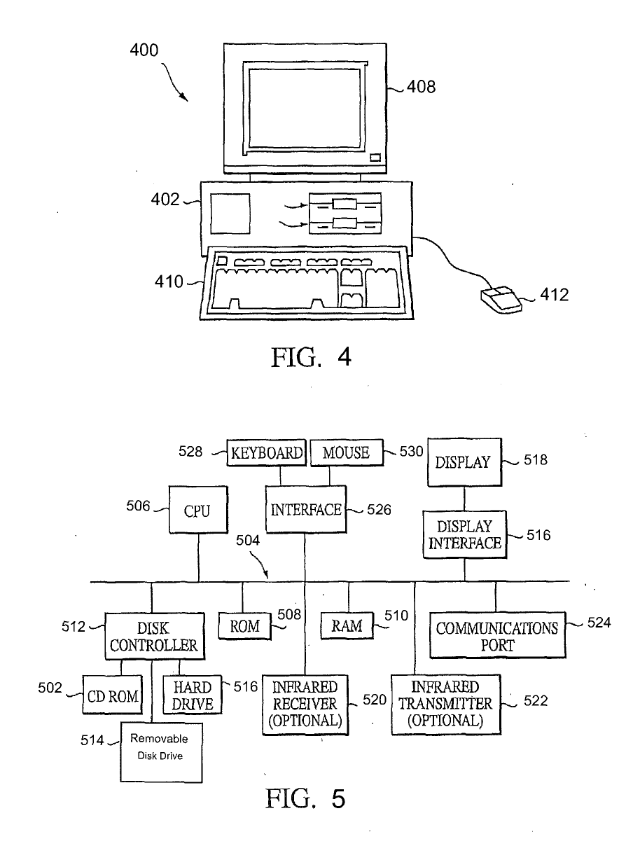

The processes and procedures of the present invention may be implemented in any computer system or computer-based controller or device. One example of such a system is described in greater detail below with reference to FIG. 4. More specifically, FIG. 4 is an illustration of a computer 400 used for implementing the computer processing in accordance with a computer-implemented embodiment of the present invention. The procedures described above may be presented in terms of program procedures executed on, for example, a computer or network of computers, including local and/or global area networks such as the Internet.

Viewed externally in FIG. 4, computer 400 has a central processing unit (CPU) 402 having disk drives 404, 406. Disk drives 404, 406 are merely symbolic of a number of disk drives that might be accommodated by computer 400, internally or externally attached. Typically, these might be one or more of the following: a removable disk drive 404, a hard disk drive (not shown), and a CD ROM or digital video disk, optical disk memory, solid-state drive (SSD), memory card, thumb drive, etc., as indicated by the slot at 406. The number and type of drives varies, typically with different computer and/or device configurations. Disk drives 404, 406 are, in fact, options, and for space considerations, may be omitted from the computer system used in conjunction with the processes described herein.

Computer 400 also has a display 408 upon which information may be displayed. The display is optional for the computer used in conjunction with the system described herein. A keyboard 410 and/or a pointing device 412, such as a mouse 412, may be provided as input devices to interface with central processing unit 402. To increase input efficiency, keyboard 410 may be supplemented or replaced with a scanner, card reader, or other data input device. The pointing device 412 may be a mouse, touch pad control device, track ball device, touch screen, or any other type of pointing device.

Alternatively or additionally, referring to FIG. 5, computer 400 may also include a CD ROM reader and writer 502, which are interconnected by a bus 504 along with other peripheral devices supported by the bus structure and protocol. Bus 504 serves as the main information highway interconnecting other components of the computer.

FIG. 5 illustrates a block diagram of the internal hardware of the computer of FIG. 4. CPU 506 is the central processing unit of the system, performing calculations and logic operations required to execute a program. Read only memory (ROM) 508 and random access memory (RAM) 510 constitute the main memory of the computer. Disk controller 512 interfaces one or more disk drives to the system bus 504. These disk drives may be removable disk drives such as 514, or CD ROM or DVD (digital video/versatile disk) drives, as at 502, or internal or external hard drives 516. As previously indicated these various disk drives and disk controllers are optional devices.

A display interface 516 permits information from bus 504 to be displayed on the display 518. Again, as indicated, the display 518 is an optional accessory for a central or remote computer in the communication network, as are infrared receiver 520 and transmitter 522. Communication with external devices occurs using communications port 524.

In addition to the standard components of the computer, the computer may also include an interface 526, which allows for data input through the keyboard 528 or pointing device, such as a mouse 530, or a touch-screen.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As another example, the system according to the invention may include a general purpose computer, or a specially programmed special purpose computer. The user may interact with the system via e.g., a personal computer or over PDA, e.g., the Internet or Intranet, etc. Either of these may be implemented as a distributed computer system rather than a single computer. Moreover, the processing could be controlled by a software program on one or more computer systems or processors, or could even be partially or wholly implemented in hardware, such as a digital imaging device or other hand-held device.

Although the computer system 400 in FIG. 4 is illustrated as having a single computer, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on removable disk, provided on CD ROM, provided on optical disk memory, etc.

Any presently available or future developed computer software language and/or hardware components can be employed in such embodiments of the present invention. For example, at least some of the functionality mentioned above could be implemented using Visual Basic, C, C++, Ruby, or any assembly language appropriate in view of the processor being used. It could also be written in an interpretive environment such as Java and transported to multiple destinations to various users.

The many features and advantages of the embodiments of the present invention are apparent from the detail specification, and thus, it is intended by the appended claims to cover all such features and advantages of the invention that fall within the true spirit and scope of the invention. Further, since numerous modifications and variations were readily occurred to those skilled in the art, it is not desired to limit the invention to the exact construction and operation illustrated and described, and accordingly, all suitable modifications and equivalents may be resorted to, falling within the scope of the invention.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

The system according to the invention may include a general purpose computer, or a specially programmed special purpose computer. The user may interact with the system via e.g., a personal computer, smartphone, tablet, or over PDA, e.g., the Internet, an Intranet, etc. Any of these, or their equivalents, may be implemented as a distributed computer system rather than a single computer. Similarly, the communications link may be a dedicated link, a modem over a POTS line, the Internet and/or any other method of communicating between computing devices and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, tablet, mainframe and super computers, as well as processing system network combinations of the same. Further, portions of the system may be provided in any appropriate electronic format, including, for example, provided over a communication line as electronic signals, provided on CD and/or DVD, provided on optical disk memory, solid-state drive (SSD), memory card, thumb drive, etc.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention.

We claim:

1. A computer-implemented method of providing a volume and revenue maximizing retail sales platform comprising the at least one of sequential, non-sequential, and sequence-independent steps of:
transmitting, by a network server, at least one sales offering of one or more comparable items associated with at least one vendor to a plurality of potential buyers;
receiving, via the network server, at least one respective purchase offer, for at least one of the one or more comparable items, from each of a plurality of interested buyers during a sales offer period;
determining, by an application computer processor, a first average purchase offer comprising an average of at least a portion of the plurality of purchase offers received from the network server;
comparing, by the application computer processor, the first average purchase offer with at least one sales trigger price associated with the at least one vendor; and
executing, by the application computer processor, a sale to each interested buyer whose purchase offer was included in the determination of the first average purchase offer when the first average purchase offer is within a predefined range associated with the at least one sales trigger price, and when a first predefined volume of purchase offers have been received.

2. The method of claim 1, further comprising, when the first average purchase offer is not within the predefined range associated with the at least one sales trigger price, determining, by the application computer processor, a second average purchase offer comprising an average of the portion of the plurality of purchase offers considered in the determination of the first average purchase offer excluding at least one previously considered purchase offer;
comparing, by the application computer processor, the second average purchase offer with the at least one sales trigger price associated with the at least one vendor; and
executing, by the application computer processor, a sale to each interested buyer whose purchase offer was included in the determination of the second average purchase offer when the second average purchase offer is within the predefined range associated with the at least one sales trigger price, and when the first predefined volume of purchase offers have been received.

3. The method of claim 1, wherein the predefined range associated with the at least one sales trigger price comprises a set of all values at least one of equal to and greater than the at least one sales trigger price.

4. The method of claim 2, wherein the at least one previously considered purchase offer that is excluded is the lowest remaining previously considered purchase offer.

5. The method of claim 2, further comprising transmitting, by the network server, at least one communication to each interested buyer whose purchase offer was included in the determination of the first average purchase offer but excluded from the determination of the second average purchase offer, and whose purchase offer is not within the range associated with the at least one sales trigger price;
wherein the communication comprises at least one of an amount by which each interested buyer would be required to raise their offer to meet the first average purchase offer, the at least one sales trigger price, the retail price, any other predefined price or price range, a revised offer, and request for another bid without specifying a suggested price or price range.

6. The method of claim 1, further comprising executing, by the application computer processor, a sale to each interested buyer whose purchase offer was not included in the determination of the of the first average purchase offer but whose purchase offer is within the predefined range associated with the at least one sales trigger price.

7. The method of claim 1, further comprising transmitting, by the network server, at least one communication to each interested buyer whose purchase offer was not included in the determination of the first average purchase offer and whose purchase offer is not within the range associated with the at least one sales trigger price;
wherein the communication comprises at least one of an amount by which each interested buyer would be required to raise their offer to meet the first average purchase offer, the at least one sales trigger price, the retail price, any other predefined price or price range, a revised offer, and request for another bid without specifying a suggested price or price range.

8. The method of claim 1, wherein the sales offer period is a vendor selected offer period.

9. The method of claim 1, further comprising, when the number of received purchase offers exceeds the number of available one or more comparable items, executing, by the application computer processor, sales based on at least one of a first-in-time rule and a highest purchase offer rule.

10. The method of claim 1, wherein the one or more comparable items comprises at least one of a product and a service.

11. The method of claim 1, wherein at least one of the steps of determining the first average purchase offer, comparing the first average purchase offer with the at least one sales trigger price set by the at least one vendor, and executing the sale to each interested buyer whose purchase offer was included in the determination of the first average purchase offer, occurs at least one of in real time as purchase offers are received, at a predefined time or interval during the sales offer period, and at the end of the sales offer period.

12. The method of claim 1, further comprising adjusting, by the application computer processor, the at least one sales trigger price, at least one of in real time and at the end of the sales offer period, responsive to at least one of a request associated with a vendor, a predefined change in circumstances, and at least a second predefined volume of received purchase offers.

13. The method of claim 1, further comprising, when the first predefined volume of purchase offers have been received, but the first average purchase offer is not within the predefined range associated with the at least one sales trigger price, executing, by the application computer processor, a sale to each interested buyer whose purchase offer is within the range associated with the at least one sales trigger price, at least one of in real time as purchase offers are received, at a predefined time or interval during the sales offer period, and at the end of the sales offer period.

14. The method of claim 13, further comprising transmitting, by the network server, at least one communication to each interested buyer whose purchase offer was included in the determination of the first average purchase offer and whose purchase offer is not within the predefined range associated with the at least one sales trigger price;
wherein the communication comprises at least one of an amount by which each interested buyer would be required to raise their offer to meet the first average purchase offer, the at least one sales trigger price, the retail price, any other predefined price or price range, a revised offer, and request for another bid without specifying a suggested price or price range.

15. The method of claim 1, further comprising, when the number of received purchase offers exceeds the number of available one or more comparable items, aggregating, by the application computer processor, one or more additional comparable items associated with at least one additional vendor, and
executing, by the application computer processor, sales based on at least one of a first-in-time rule and a highest purchase offer rule.

16. A computer-implemented system for providing a volume and revenue maximizing retail sales platform comprising:
a network server, configured to transmit at least one sales offering of one or more comparable items associated with at least one vendor to a plurality of potential buyers, and to receive at least one respective purchase offer, for at least one of the one or more comparable items, from each of a plurality of interested buyers during a sales offer period; and
an application computer processor configured to:
determine a first average purchase offer comprising an average of at least a portion of the plurality of purchase offers received from the network server;
compare the first average purchase offer with at least one sales trigger price associated with the at least one vendor; and
execute a sale to each interested buyer whose purchase offer was included in the determination of the first average purchase offer when the first average purchase offer is within a predefined range associated with the at least one sales trigger price, and when a first predefined volume of purchase offers have been received.

17. The system of claim 16, wherein the predefined range associated with the at least one sales trigger price comprises a set of all values at least one of equal to and greater than the at least one sales trigger price.

18. A computer-implemented method of providing a volume and revenue maximizing retail sales platform comprising the at least one of sequential, non-sequential, and sequence-independent steps of:
transmitting, by a network server, at least one sales offering of one or more comparable items associated with at least one vendor to at least one buyer;
receiving, via the network server, at least one respective purchase offer, for at least one of the one or more comparable items, from the at least one buyer;
determining, by an application computer processor, an average purchase offer comprising an average of at least a portion of the purchase offers received from the network;
comparing, by the application computer processor, the average purchase offer with at least one sales trigger price associated with the at least one vendor; and
executing, by the application computer processor, a sale to the at least one buyer when the average purchase offer is within a predefined range associated with the at least one sales trigger price.

19. The method of claim 18, wherein the predefined range associated with the at least one sales trigger price comprises a set of all values at least one of equal to and greater than the at least one sales trigger price.

20. The method of claim 18, further comprising, when the number of received purchase offers exceeds the number of available one or more comparable items, aggregating, by the application computer processor, one or more additional comparable items associated with at least one additional vendor, and
executing, by the application computer processor, sales based on at least one of a first-in-time rule and a highest purchase offer rule.
